(19) United States
(12) Patent Application Publication
(10) Pub. No.: US 2005/0270228 A1
(43) Pub. Date: Dec. 8, 2005

(54) Radar system for local positioning

(76) Inventor: Scott Adam Stephens, Phoenix, AZ (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/103,964

(22) Filed: Apr. 11, 2005

Related U.S. Application Data
(63) Continuation-in-part of application No. 10/614,097, filed on Jul. 3, 2003.

(51) Int. Cl. G01S 13/08

(52) U.S. Cl. 342/146; 342/188; 342/126

(57) ABSTRACT

A positioning system includes one or more active landmarks and a device. The device transmits an electromagnetic pulse having a polarization and receives return signals over a period of time. The device may preferentially receive return signals having the polarization. The return signals include at least one return modulated pulse from at least one active landmark. The device processes the return signals to isolate the return modulated pulse from the return signals and to determine a range from the device to the active landmark. The device optimally moves in a particular direction while receiving the return signals, detects a Doppler shift in the return modulated pulse portion of the return signals and determines an angle between the particular direction and a straight line between the device and the active landmark.

This application is a continuation-in-part of U.S. patent application Ser. No. 10/614,097, filed Jul. 3, 2003, pending. U.S. patent application Ser. No. 10/614,097 is incorporated herein by reference in its entirety.

### FIELD OF THE INVENTION

The present invention relates generally to positioning systems and more specifically, to a system and method for determining the position of a mobile device relative to a number of active landmarks via coherent radio-frequency ranging techniques.

### BACKGROUND OF THE INVENTION

Local positioning systems are becoming an important enabler in mobile devices requiring navigation capabilities, especially in applications of autonomous vehicles and precision construction tools. Global positioning systems such as GPS provide only medium accuracy position information, usually no better than 10 cm, and require a clear view of the sky to near the horizon. Local positioning systems, with either active or passive components distributed in a working volume, can allow much more accurate (<1 cm) positioning, and allow the user to expand the system as necessary to operate in even the most complex enclosed geometries.

Conventional local positioning systems include acoustic and laser ranging systems. Acoustic systems typically use transponder beacons to measure range within a network of devices, some of which are fixed to form the local coordinate system. Unfortunately, because of the properties of sound propagation through air, acoustic systems can only measure range to accuracies of a centimeter or more, and only over relatively short distances. Local positioning systems based on lasers utilize measurements of both the angle and range between a device and one or more reflective objects, such as prisms, to triangulate or trilateralate the position of the device. However, laser systems currently employ expensive pointing mechanisms that can drive the system cost to $30K or more.

A relatively low-cost (≦$2000) local positioning system able to determine 2D or 3D positions to accuracies of a few millimeters would enable a large set of potential products, in such application areas as precision indoor and outdoor construction, mining, precision farming and stadium field mowing and treatment. The present invention overcomes the cost and accuracy limitations of conventional local positioning systems.

### SUMMARY

In a low-cost, yet highly accurate, local positioning system, electromagnetic pulses are used to determine ranges and, optionally, angles between a device and a number of active landmarks. The propagation speed of the electromagnetic pulses does not vary as strongly with environmental conditions as does that of acoustic signals, providing superior accuracy in ranging. The spatial beamwidths of the antennas used to transmit electromagnetic pulses are substantially wider than those of lasers, eliminating the need for costly pointing mechanisms. The use of active landmarks allows modulation of the pulses such that a distinct signature of a respective landmark can be determined.

In one embodiment, the position of a device relative to one or more active landmarks is determined by transmitting a pulse having a polarization and a first carrier signal frequency from the device and receiving a return signal over a period of time, including preferentially receiving the return signal having the polarization. The return signal includes a return modulated pulse from at least one active landmark. The return signal is processed so as to isolate the return modulated pulse from the return signal and to determine a range from the device to at least one active landmark based on a time of arrival of the return modulated pulse.

The return modulated pulse may be modulated using amplitude modulation or frequency modulation. In some embodiments, a square wave is used to frequency modulate the return modulated pulse. The square wave may be encoded to eliminate ambiguity in a time of arrival of the return modulated pulse. The square wave may also be periodically encoded to distinguish round-trip paths that are a multiple of a repetition period of the transmitted pulse. In addition, in embodiments with more than one active landmark, the modulation of the return modulated pulse from a respective active landmark may be distinct from that used by all other active landmarks.

In some embodiments, the device or the respective active landmark are moved at a known velocity in a particular direction while performing the receiving. The device detects a Doppler shift in the return modulated pulse in the return signal and determines an angle between the particular direction and a straight line between the device and the respective active landmark as a function of the detected Doppler shift. In some embodiments, the method may also include determining the position of the device using radar-to-radar ranging with a second device.

In some embodiments, the device includes a separate transmit antenna and a separate receive antenna, and also includes a de-coherence plate to reduce cross-talk between the transmit antenna and the receive antenna.

In some embodiments, the device is further configured to store at least a calibrated delay for at least a respective active landmark and the range from the device to the active landmark is determined using the calibrated delay.

In some embodiments, the active landmarks include a receive antenna for receiving a receive signal corresponding to the transmitted electromagnetic pulse, an amplifier for amplifying the receive signal, a signal generator for generating a modulating signal, a mixer for modulating the receive signal with the modulating signal to produce a transmit modulated signal and a transmit antenna for transmitting a return electromagnetic modulated pulse corresponding to the transmit modulated signal. The transmit and receive antennas may be combined in a common antenna. In addition, the active landmarks may be proximate to a passive reflective structure to increase a radar cross section of the active landmarks.

Additional variations on the method and apparatus embodiments are provided.

### BRIEF DESCRIPTION OF THE DRAWINGS

Additional objects and features of the invention will be more readily apparent from the following detailed description and appended claims when taken in conjunction with the drawings.

FIG. 1 is a diagram illustrating the position system, including a device, a number of active landmarks and a variety of clutter objects. The device transmits a pulse and receives a return signal including a return modulated pulse from an active landmark.

FIG. 2 illustrates the return modulated electromagnetic pulse from an active landmark in the positioning system.

FIG. 3A illustrates amplitude modulation of the return modulated pulse with a sine wave.

FIG. 3B illustrates frequency modulation of the return modulated pulse with a square wave.

FIG. 4A illustrates the device moving with a particular velocity, so that the return modulated pulse in the return signal will contain a Doppler shift.

FIG. 4B illustrates the active landmark moving with a particular velocity, so that the return modulated pulse in the return signal will contain a Doppler shift.

FIG. 5 illustrates the range and angular bins corresponding to positions of the device relative to the active landmarks.

FIG. 6 is a block diagram, illustrating the components of a typical device for use in the positioning system.

FIG. 7 is a block diagram, illustrating the components of an embodiment of the active landmark for use in the positioning system.

FIG. 8 is an illustration of a mechanical modulator for amplitude modulation of the return modulated pulse.

FIG. 9 is an illustration of an active landmark capable of having a time and spatial varying reflectivity on a surface for amplitude modulation of the return modulated pulse.

FIG. 10 is an illustration of an active landmark proximate to a passive reflective structure, including a first passive reflecting surface, a second passive reflecting surface and a structure for positioning the second surface at an angle relative to the first surface.

FIG. 11 is an illustration of radar-to-radar ranging between a device and a second device.

FIG. 12 is an illustration of a de-coherence plate to reduce cross-talk between a transmit antenna and a receive antenna in the device.

Like reference numerals refer to corresponding parts throughout the several views of the drawings.

### DETAILED DESCRIPTION OF THE DRAWINGS

Reference will now be made in detail to embodiments of the invention, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the present invention.

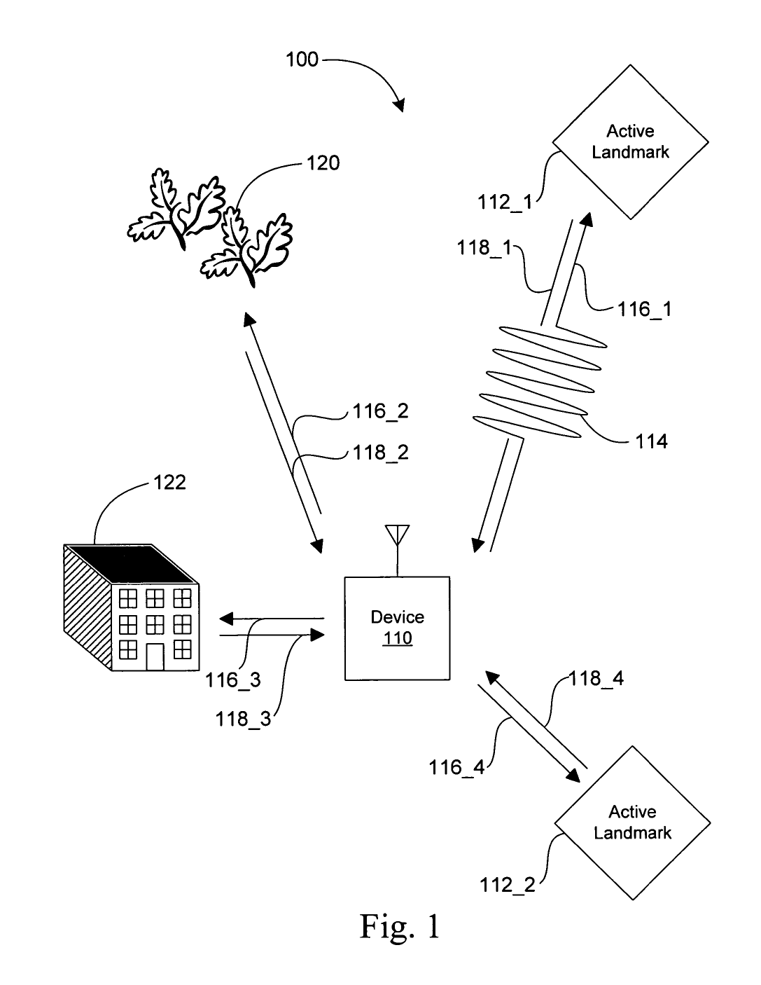

Referring to FIG. 1, a local positioning system 100 includes a device 110 and a number of active landmarks 112 whose position is fixed or whose average position is fixed. The active landmarks 112 may be placed at surveyed locations. Alternately, the active landmarks 112 may be placed at arbitrary positions that are automatically determined during an initial system self-calibration procedure. In either case, the position of device 110 is determined relative to the position of one or more of the active landmarks 112 by determining one or more ranges, each range relating to a distance between the device 110 and an active landmark, such as active landmark 112_1.

The device 110 is configured to transmit at least one electromagnetic pulse 114 in a number of directions 116. In some embodiments, the device 110 is configured to transmit a plurality of electromagnetic pulses, such as the pulse 114, in a number of directions 116. In an exemplary embodiment, the electromagnetic pulse 114 is about 1 nanosecond (ns) in duration and has a carrier signal frequency of about 6 gigahertz (GHz). A typical repetition period for the pulse 114 is about one microsecond. Other embodiments may employ pulse duration and carrier signal frequency pairings of: 1 ns and 24 GHz; 5 ns and 6 GHz; and 1 ns and 77 GHz. The increased accuracy of range estimation available from shorter pulse durations and higher carrier signal frequencies comes at the expense of increased cost and complexity of associated circuitry in some embodiments.

The device 110 is further configured to receive return signals 118 over a period of time. The return signals 118 include a return modulated electromagnetic pulse from one or more active landmarks 112. The return signals consist of contributions from a number of reception directions 118. Some reception directions 118 include reflected pulses from “clutter,” objects other than the active landmarks 112 that return the return modulated pulses. For example, foliage 120, when illuminated by an electromagnetic pulse transmitted along direction 116_2, will reflect an electromagnetic pulse along direction 118_2. Similarly, building 122, when illuminated by an electromagnetic pulse transmitted along direction 116_3, will reflect an electromagnetic pulse along direction 118_3.

To determine the respective range between the device 110 and an active landmark, such as active landmark 112_1, the device 110 needs to isolate at least a return modulated pulse from at least a return signal, which may also include reflected pulses from the clutter. To facilitate isolation of the return modulated pulse from the active landmark 112_1, the active landmark 112_1 modulates the return modulated pulse. In some embodiments, the device 110 isolates the return modulated pulse from the return signal by demodulating the return signal using a replica of the signal used by the active landmark to generate the return modulated pulse.

In some embodiments, the modulation used by the active landmark to generate the return modulated pulse is amplitude modulation, such as single side band, double side band or double side band suppressed carrier modulation.

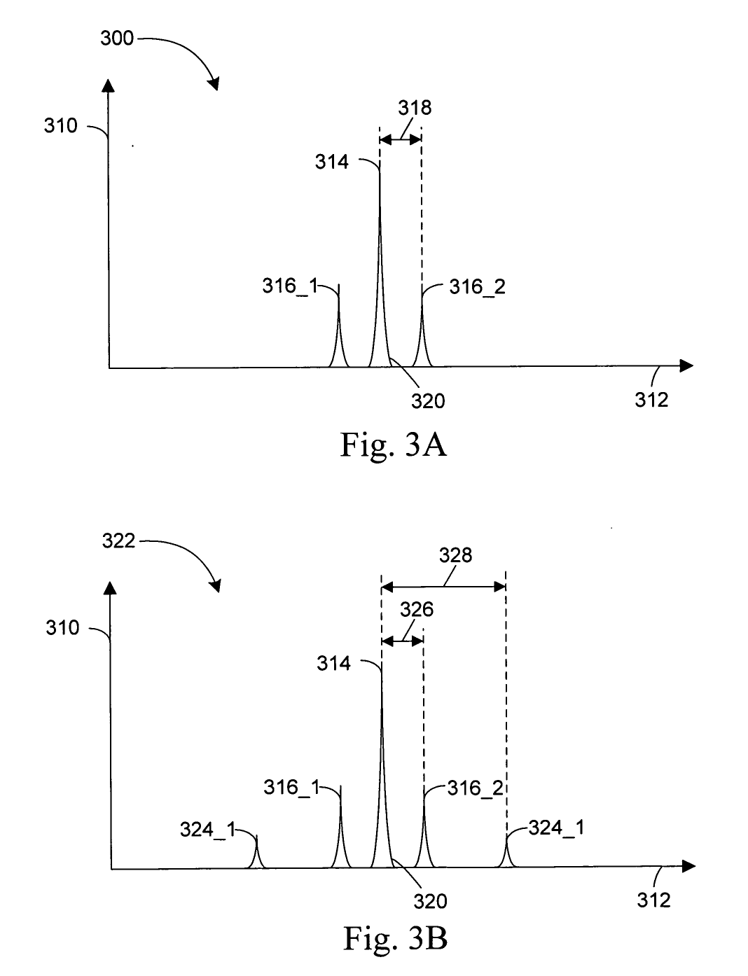

Frequency spectrum 300 in FIG. 3A, showing magnitude 310 as a function of frequency 312, illustrates amplitude modulation of the return pulse by an active landmark using a sine wave with a depth of modulation less than 1. There is a carrier signal frequency 314 with sidebands having sideband frequencies 316. In this example, the sideband frequencies 316 are shifted relative to the carrier signal frequency 314 by a sine wave frequency 318. This frequency shift is larger than the width of a band of frequencies 320 corresponding to Doppler shifts associated with relative motion of the device 110 (FIG. 1) and objects within its radar detection area.

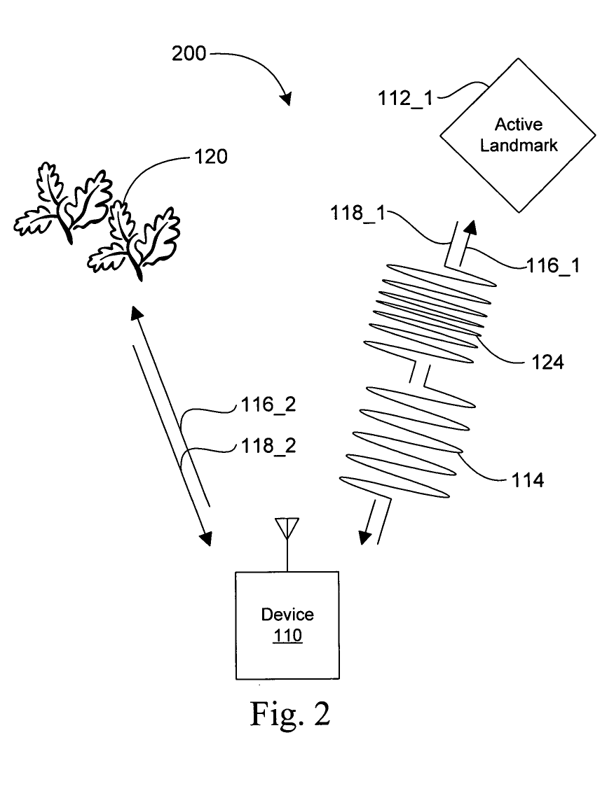

In other embodiments, the modulation is frequency modulation, including narrow band or wide band frequency modulation. FIG. 2 illustrates an embodiment using frequency modulation. Frequency modulation allows the device 110 to isolate a return modulated pulse 124 from the return signals including the reflected pulse from the foliage 120.

Frequency spectrum 322 in FIG. 3B illustrates an exemplary embodiment in which the return modulated pulse 124 (FIG. 2) is frequency modulated using a square wave having fundamental frequency 326. In frequency modulation using other modulating signals, such as a sine wave, the modulation is characterized by a central frequency. In the example shown in FIG. 3B, the fundamental frequency 326 of the square wave (used for modulation) is much smaller than the carrier signal frequency 314 of the primary return pulse signal, resulting in a small modulation index. As a consequence, in the frequency spectrum 322 only the first-order sidebands are shown. The use of square wave modulation, however, results in multiple sidebands. The sidebands, corresponding to a fundamental and third harmonic of the square wave, having sideband frequencies 316 and 324 are shown in FIG. 3B. In this example, the sideband frequencies 316 and 324 are shifted relative to the carrier signal frequency 314 by the fundamental frequency 326 and a third harmonic frequency 328. Both the fundamental frequency 326 and the third harmonic frequency 328 are larger than the band of frequencies 320 corresponding to Doppler shifts associated with relative motion of the device 110 and objects within its radar detection area. In an exemplary embodiment, the fundamental frequency 326 is several hundred Hertz.

Referring back to FIG. 1, in embodiments including multiple active landmarks 112, the return modulated pulse from an active landmark, such as active landmark 112_1, may be distinct from that used by all other active landmarks 112. For example, for square wave modulation the active landmarks 112 each may have a distinct fundamental frequency 326 (FIG. 3B). For other modulating signals, such as a sine wave, the active landmarks 112 each may have a distinct central frequency. Alternatively, return modulated pulses from a plurality of the active landmarks 112 may be distinct from one another. In this case, these return modulated pulses may have distinct fundamental frequencies or distinct central frequencies from one another. In addition to frequency division multiple access, in other embodiments the return modulated pulses from a plurality of active landmarks 112 may be distinguished from one another by using time division multiple access or code division multiple access.

To further discriminate between the return modulated pulses and reflected pulses from clutter, in some embodiments the device 110 transmits the pulse 114 having a polarization. The return modulated pulses produced by the active landmarks 112 also have the same polarization. Suitable polarizations include linear polarization, elliptical polarization, right-hand elliptical polarization, left-hand elliptical polarization, right-hand circular polarization (RHCP) and left-hand circular polarization (LHCP). Right-hand elliptical polarization, left-hand elliptical polarization, RHCP and LHCP are particularly advantageous. As an example, RHCP is considered, although the discussion is relevant for the other right- and left-hand polarizations.

When the device 110 transmits the pulse 114 having RHCP, clutter, for example, foliage 120, will reflect an electromagnetic pulse having a primarily opposite circular polarization, i.e., LHCP, along reception direction 118_2. Similarly, single-bounce reflections from building 122 will result in a reflected pulse having LHCP polarization along reception direction 118_3. Return modulated pulses from active landmarks 112, however, will have RHCP. Thus, the device 110 may further isolate return modulated pulses, such as the return modulated pulse transmitted by the active landmark 112_1, in part, by using a receiver configured to preferentially receive signals having the same polarization as the transmitted electromagnetic pulse 114. In addition to improving isolation of the return modulated pulses, in these embodiments a common polarization of transmitted pulses and the return modulated pulses allows the device 110 and the active landmarks 112 each to use a single antenna for transmitting and receiving.

Once the return modulated pulse, such as the return modulated pulse 124, from an active landmark 112, such as active landmark 112_1, is isolated from the return signal received by the device 110, a range between the device 110 and the active landmark 112_1 is determined. Assuming that pulses travel in straight lines and that there is no multipath propagation, a pulse 114 transmitted by device 110 and reflected by an object some distance r away from the device 110 will arrive at the device 110 with a time of arrival (ToA),

$$ToA = 2 \frac{r}{c} , \qquad ( Equation 1 )$$

where c is the propagation speed of electromagnetic signals. The propagation speed of electromagnetic signals, c, is known to be approximately 3.0*10⁸ m/s in a vacuum. In typical atmospheric conditions, the propagation speed of electromagnetic signals deviates from this value by less than 300 ppm (parts per million). By employing information about the altitude and other environmental factors the propagation speed of electromagnetic signals in the environment of the positioning system can be determined to within 100 ppm.

For the return modulated pulses from the active landmarks 112 there may be an additional delay Δ associated with the receiving of a receive signal corresponding to the transmitted pulse 114, modulating the receive signal with a modulating signal to produce transmit modulated signals and the transmitting of return modulated pulses corresponding to the transmit modulated signals in the active landmarks 112. A modified expression for the time of arrival is

$$ToA = 2 \frac{r}{c} + Δ . \qquad ( Equation 2 )$$

The delay Δ may not be the same for each active landmark 112; however, the delay Δ for a respective active landmark may be calibrated during a calibration procedure (e.g., a system self-calibration procedure) and the time of arrival of return modulated pulses may be corrected during subsequent measurements. Thus, determination of the time of arrival corresponding to one or more return modulated pulses can be used to accurately determine the range between the device 110 and one or more active landmarks 112.

Although FIG. 1 shows only two active landmarks 112, in other embodiments more, or fewer, active landmarks 112 may be present. In some embodiments, the number of active landmarks 112 used will be adequate to provide unambiguous determination of the position of the device 110 relative to active landmarks 112 whose position have been surveyed. For example, if the positions of three active landmarks 112 that are not collinear are known, e.g., by surveying them in advance, and the device 110 and the active landmarks 112 are located substantially within a two-dimensional plane, it is possible to determine the position of the device 110 unambiguously from knowledge of the range from the device 110 to each of the active landmarks 112. Alternatively, if the active landmarks 112 and the device 110 are not substantially coplanar, the use of four active landmarks 112 with known positions will allow the unambiguous determination of the position of the device 110 from knowledge of the range from the device 110 to each of the active landmarks 112. Algorithms for the determination of position based on one or more ranges are well-known to one of skill in the art. See, for example “Quadratic time algorithm for the minmax length triangulation,” H. Edelsbruneer and T. S. Tan, pp. 414-423 in Proceedings of the 32nd Annual Symposium on Foundations of Computer Science, 1991, San Juan, Puerto Rico, hereby incorporated by reference in its entirety.

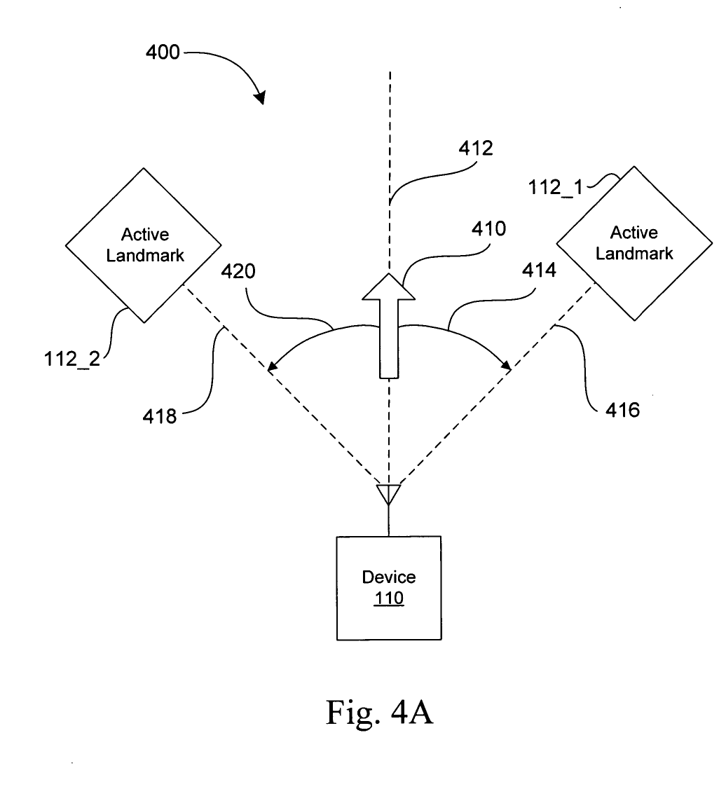

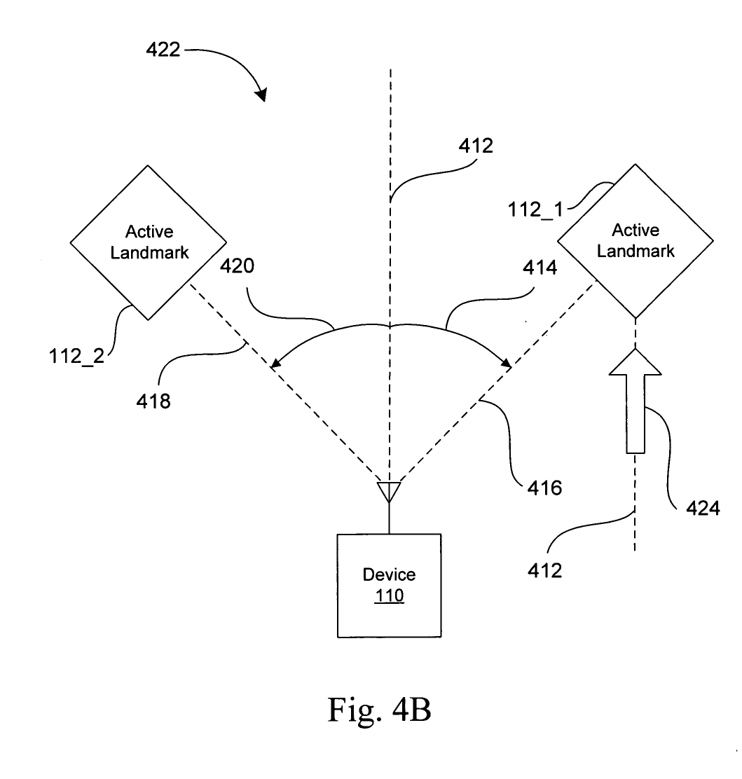

Referring to FIG. 4A, in addition to determining the range from the device 110 to one or more active landmarks 112, such as active landmark 112_1, in some embodiments, such as the local positioning system 400, the device 110 moves with a velocity v 410 in a particular direction 412 while transmitting the pulse 114 (FIG. 1). The device 110 receives the return signals over a period of time. Return modulated pulses from the active landmark 112_1 received by the device 110 will be Doppler shifted in frequency, in accordance with

$$f = {f}_{c} ( 1 + \frac{v}{c} cos ( θ ) ) , \qquad ( Equation 3 )$$

where f_{c} is the carrier signal frequency 314 (FIG. 3), f is the received carrier signal frequency of the return modulated pulses as received by the device 110, c is the propagation speed of electromagnetic signals in the atmosphere that fills the space between the device 110 and the active landmark 112_1, and θ is an angle 414 between the direction 412 of device movement and the straight line 416 between the device 110 and the active landmark 112_1. Thus, from the received carrier signal frequency of one or more return modulated pulses, the device 110 can determine the angle θ 414. Note that for a respective received carrier signal frequencyf however, there are at least two angles that satisfy Equation 3. This is so because, for any angle θ₀ that solves Equation 3, the angle −θ₀ also solves Equation 3. In FIG. 4A, these two angles correspond to the angle θ 414 between direction 412 and line 416 between the device 110 and the active landmark 112_1, and the angle −θ 420 between direction 412 and line 418. As shown in FIG. 4B, in some embodiments, such as embodiment 422, the active landmark 112_1 moves with a velocity v 424 in a particular direction 412 about an average fixed position allowing the angle θ 414 to be determined from the resulting Doppler shift. Note that in these embodiments the Doppler shift provides information about the complement to the angle θ 414.

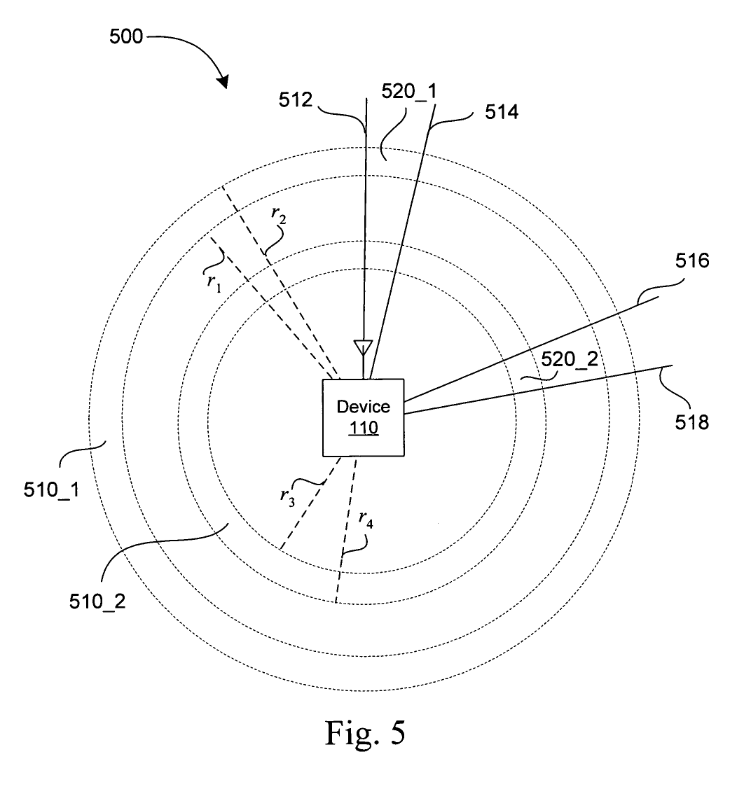

The combination of range information and, if needed, angular information between the device 110 and the active landmarks 112 allows the position of the device 110 to be determined. Typically, the local positioning system will be able to establish or determine the position an active landmark, such as active landmark 112_1, with a resolution of 1 cm or better. This is illustrated in FIG. 5 for a local positioning system 500. Active devices 112 (FIG. 1) are in range bins 510, defined by ranges r₁, r₂, r₃ and r₄ (determined from the time of arrival of the return modulated pulses) and angular bins 520, defined by angles 512, 514, 516 and 518. In an exemplary embodiment, the position of the device 110 may be determined with an accuracy of 1 cm or better.

The use of a simple modulation signal such as a square wave to modulate the return modulated signals is advantageous in helping to minimize the cost of the local positioning system. In light of the previous description of how the range, and thus the position, of the device 110 (FIG. 1) is determined from the time of arrival of the return modulated pulses, the use of square wave modulation also poses additional challenges. In particular, a square wave is identical under the operations of inversion and phase shift. This makes resolution of ambiguity in a carrier signal phase and thus the time of arrival of the return modulated pulses more difficult, since the carrier signal phase can only be known to within half of a period because the phase of the modulating signal is lost during demodulation by the device 110 (FIG. 1). In some embodiments, this ambiguity can be eliminated by encoding the square wave signal such that it is not identical when inverted at any phase shift. Encoding techniques that may be used by the active landmarks include on-off keying, quadrature amplitude modulation, frequency shift keying, continuous phase frequency shift keying, phase shift keying, differential phase shift keying, quadrature phase shift keying, minimum shift keying, Gaussian minimum shift keying, pulse position modulation, pulse amplitude modulation and pulse width modulation.

One possible encoding pattern is a periodic binary phase shift keying (BPSK) waveform ++−, where + denotes a pulse with a positive amplitude and − a pulse with a negative amplitude, and the chip rate corresponding to the bit cell of the BPSK waveform is the same as that of the square wave. However, it is also desirable to have a dc-free waveform, since a waveform having energy at zero frequency will interact with signals associated with clutter. Examples of zero-average periodic BPSK waveforms are ++−−+− and ++++−−−+−−. These waveforms can be used with other encoding techniques than one with a constant envelope, i.e., phase modulation. Nonetheless, phase modulation is often easier and less costly to implement than most other encoding techniques.

In addition to having complex phase, such as the square wave example with the sinusoidal phase modulation above, BPSK waveforms may be implemented with different amplitude sequences. Suitable amplitude sequences include pseudo-random noise sequences, Walsh codes, Gold codes, Barker codes and codes, such as dc-free codes, with an autocorrelation (to reduce or eliminate ambiguity in the time of arrival) and/or a cross-correlation (for embodiments with multiple devices, such as device 110, or and/or multiple active landmarks 112) with a value substantially near 1 at zero time offset and substantially near zero at non-zero time offset.

The use of a fixed repetition period in the local positioning system poses challenges, too. In particular, the system may not be able to distinguish objects separated, in terms of the time of arrival, by multiples of the repetition time except by analyzing the strength of the return signals and using known radar cross sections of the landmarks. This is particularly problematic if the return modulated pulses from the active landmarks 112 (FIG. 1) are not all distinct from one another. For example, if nanosecond duration pulses are transmitted by the device 110 (FIG. 1) every microsecond, return signals from objects with a time of arrival of 1100 ns will overlap those from objects with a time of arrival of 100 ns. Periodically encoding the transmitted pulses with consecutive bits from a sequence having an autocorrelation of 1 at zero time delay and substantially near zero at non-zero time delay is one way to remove this ambiguity. Ideally, the autocorrelation of the sequence at non-zero time delay is zero. Suitable sequences are provided by Walsh functions. For example, if consecutive pulses are modulated using consecutive bits in a BPSK encoding sequence +++− (the encoding repeating every 4 pulses), return signals from objects with times of arrival of 0-1000 ns, 1000-2000 ns, 2000-3000 ns and 3000-4000 ns can be distinguished.

In some embodiments, after transmitting each pulse 114 the return signals are multiplied by a current bit in the encoding sequence allowing return signals with times of arrival of 0-1000 ns to be detected. Alternatively, after transmitting each pulse 114 the return signals are multiplied by a previous bit in the encoding sequence to allow return signals with times of arrival of 1000-2000 ns to be detected. Similarly, multiplying return signals by bits shifted even further than the previous bit in the encoding sequence will allow return signals with other times of arrival to be detected. By increasing a number of bits in the encoding sequence, the technique can be extended to larger times of arrival and thus to longer ranges.

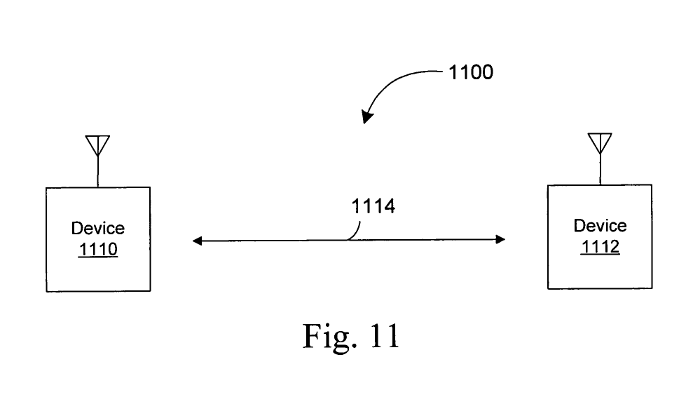

Referring to FIG. 11, the position of a first device 1110 in a local positioning system 1100 may also be determined using radar-to-radar ranging with at least a second device 1112. Signals 1114 exchanged between the first device 1110 and the second device 1112 encode data information needed for radar-to-radar ranging. Radar-to-radar ranging is advantageous since it helps overcome the signal loss at a long range R, which is proportional to R⁴, in local positioning systems using passive landmarks. Referring to FIG. 1, while the use of active landmarks 112 also helps overcome this problem, radar-to-radar ranging may be used in conjunction with the active landmarks 112 to enable the position of the device 110 to be determined for distances larger than a threshold, especially when there are constraints on the transmit power of the return modulated pulses from the active landmarks 112, for example, when the active landmarks 112 are powered by batteries. In some embodiments the threshold may be 50 m, 100 m, 250 m, 500 m, 1000 m, 5000 m or 10,000 m. Radar-to-radar ranging is further described in U.S. patent application Ser. No. 10/614,098, filed Jul. 3, 2003, entitled Two-Way RF Ranging System and Method for Local Positioning, the contents of which are incorporated by reference.

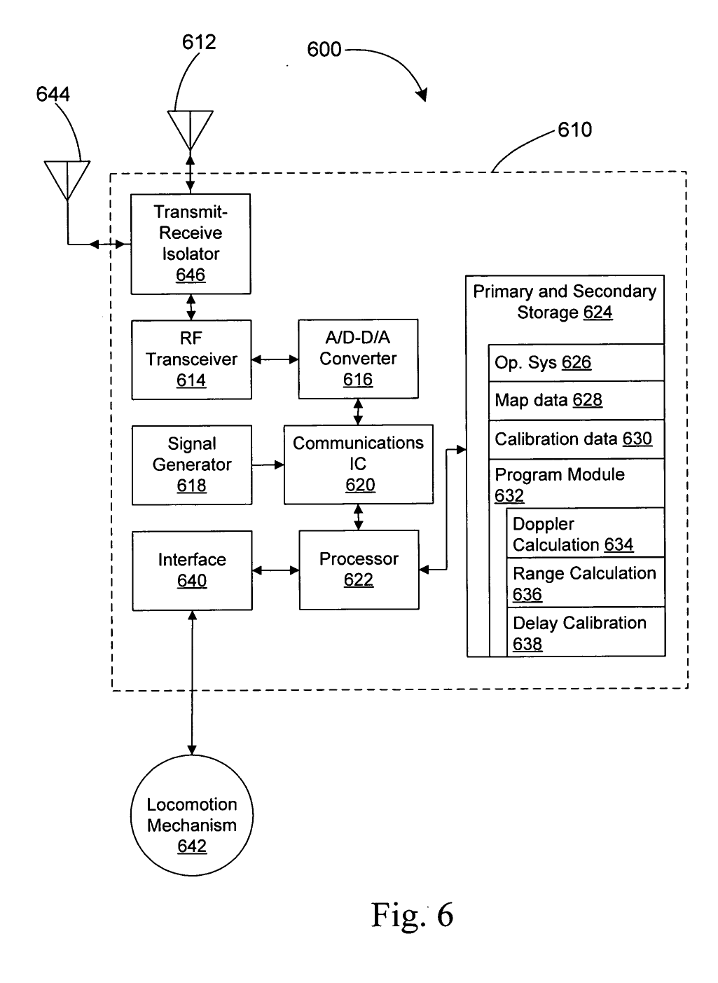

Referring to FIG. 6, a device 610 in an embodiment of a local positioning system 600 includes at least a subset of the following components:
an antenna 612 for at least transmitting electromagnetic pulses
an optional antenna 644 for receiving return signals;
an optional transmit-receive isolator 646;
a radio-frequency (RF) transceiver 614;
a digital-to-analog (D/A) and analog-to-digital (A/D) converter 616;
a signal generator 618;
an optional communications integrated circuit (IC) 620;
a processor 622;
an optional electromechanical interface circuit 640;
an optional locomotion mechanism 642 for moving the device 610 in a particular direction, at a velocity; and
memory 624, which may include high-speed random access memory and may also include non-volatile memory, such as one or more magnetic disk storage devices; memory 624 may be used to store at least a subset of the following modules, instructions and data:
an operating system 626;
map data 628;
calibration data 630; and
and at least one program module 632, executed by processor 622, the program module 632 including instructions for a Doppler calculation 634, instructions for a range calculation 636 and instructions for a delay calibration 638.

In some embodiments, program module 632 includes instructions for transmitting a pulse, such as the pulse 114 (FIG. 1), at a first position of the device 610 and at a known time, while the device 610 is stationary. In accordance with these instructions, the processor 622 sends a signal to communications IC 620 generating a digital signal. In alternative embodiments, the function of the communications IC 620 is performed by the processor 622 and the communications IC 620 is not included in the device 610. D/A converter 616 generates a pulse that is used by RF transceiver 614 to modulate a carrier signal having a carrier signal frequency. The modulated pulse is then transmitted by antenna 612. In some embodiments, the transmitted pulse has a polarization.

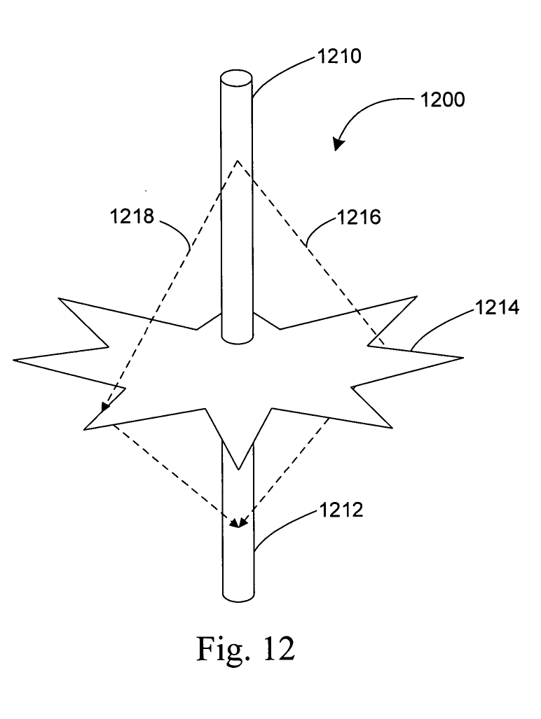

In addition to instructions for transmitting an electromagnetic pulse, program module 632 includes instructions for receiving return signals over a period of time. The receive antenna 644 receives the return signal, including one or more return modulated pulses. In some embodiments, the antenna 644 preferentially receives return signals having the same polarization as the transmitted pulse, such as the pulse 114 (FIG. 1). The device 610 may also include an optional transmit-receive isolator 646, such as a transmit-receive switch. In other embodiments, the receive antenna 644 is not included in the device 600 and instead the transmit antenna 612 is used for both transmitting and receiving. In still other embodiments, the device 610 further includes a ground plane (not shown) to reduce cross-talk between the antenna 612 and the receive antenna 644. Referring to FIG. 12, instead of a ground plane, a device 1200 may further include a de-coherence plate 1214 to reduce cross-talk between a transmit antenna 1210 and a receive antenna 1212, wherein for a plurality of paths over a range of paths from the transmit antenna 1210 to the receive antenna 1212 the de-coherence plate 1214 substantially defines a corresponding path that is 180 degrees out of phase, such as paths 1216 and 1218. The de-coherence plate 1214 may be made from materials including, but not limited to, conductors such as aluminum, copper and other metals. The de-coherence plate 1214 is further described in U.S. patent application Ser. No. 10/______, (Morgan Lewis Attorney Docket 060877-5007), filed on ______, the contents of which are incorporated by reference.

Referring to FIG. 6, in an exemplary embodiment, the antenna 612, the antenna 644 or a common antenna are each configured to transmit and/or receive an electromagnetic pulse having a particular right- or left-hand polarization, including circular and elliptical. In some embodiments, the antenna 612, the antenna 644 or the common antenna each radiate isotropically in a plane containing the active landmarks 112 (FIG. 1) and the device 610. An example of the antenna 612, the antenna 644 or the common antenna that radiates substantially isotropically in a plane and transmits electromagnetic pulses having a particular circular polarization is one formed from two cavity-backed spiral antennas, placed back-to-back. An example of such an antenna is described in “A new wideband cavity-backed spiral antenna,” Afsar et al., in Proceedings of the 2001 IEEE Antennas and Propagation Society International Symposium, vol. 4, pp. 124-127, which is hereby incorporated by reference in its entirety. In some embodiments, the antenna 612, the antenna 644 or the common antenna are each a directional horn antenna with a mechanical azimuthal actuator. In other embodiments, the antenna 612, the antenna 644 or the common antenna each include a switched beam configuration using, for instance, a Rothman lens. In other embodiments, the antenna 612, the antenna 644 or the common antenna each include electronically steerable phased-arrays. In still other embodiments the antenna 612, the antenna 644 or the common antenna are each linearly polarized, a bi-cone, a bi-cone with a ground plane, a helix, a horizontal omni-directional, an omni-directional, a hemi-directional or an isotropic antenna.

The return signal is passed to RF transceiver 614, where it is down converted to the baseband relative to the carrier signal frequency. In some embodiments, RF transceiver 614 employs quadrature phase-preserving down conversion to baseband. The in-phase component of the down conversion, the quadrature component, or both are then passed to A/D converter 616, where they are sampled. The return signals are then demodulated in the communications IC 620 using a modulating signal generated by signal generator 618 so as to isolate the return modulated pulse from the return signals. The modulating signal corresponds to the modulating signal used to generate the return modulated pulse in one or more of the active landmarks 112 (FIG. 1). In other embodiments, the demodulation occurs prior to down converting the return signal to baseband. In still other embodiments, the communications IC 620 is not included in the device 610 and the demodulation is performed in the processor 622. The return modulated pulse, isolated by demodulation of the return signal, is processed by the processor 622. In some embodiments, the processor 622 is (or includes) a microprocessor, a digital signal processor (DSP) or other central processing unit. In other embodiments, it is an application specific integrated circuit (ASIC). The processor 622 processes the return modulated pulse to determine the range from the device 610 to an active landmark, such as active landmark 112_1 (FIG. 1).

In some embodiments, the processor 622 determines the range by executing range calculation instructions 636. The processor 622 corrects the calculated range for the delay Δ associated with a respective active landmark, such as active landmark 112_1 (FIG. 1), using calibration data 630. The calibration data 630 may be produced using delay calibration instructions 638, or the calibration data 630 for the active landmarks may be produced using equipment and processes not included in the device. In other embodiments, the processor 622 may use information provided to the device 610, for example via map data 628, such as architectural plans or particular active landmark locations or orientations, to determine the range. In other embodiments, the processor 622 may store the results of a range calculation corresponding to one or more transmitted pulses in memory 624. The position of the device 610 may be refined in subsequent measurements of the range based on additional transmitted pulses and/or measurements of an angle between the device 610 and one or more active landmarks 112 (FIG. 1) based on detecting Doppler shifts in the return modulated pulse.

In some embodiments, the program module 632 includes instructions for moving the device 610 to a second position. The second position may be at a predefined separation distance from the first position. The processor 622 executes this instruction by signaling interface 640, which in turn activates locomotion mechanism 642. In some embodiments, mechanism 642 includes an electric motor, the speed of which is controlled by the level of a DC voltage provided by the interface 640. In other embodiments, the interface 640 and/or the mechanism 642 broadcasts a position determined by the program module 632 to a computer in a vehicle (not shown). The computer in the vehicle then makes decisions, based in part on the position determination, about the movement of the device 610. For example, in some embodiments, the computer in the vehicle combines information from several positioning systems, including a global positioning system (GPS). The program module 632 further includes instructions for transmitting the pulse, such as the pulse 114 (FIG. 1), at the second position of the device 610 and determining from the received return signal a second range from the device 610 to one or more active landmarks 112 (FIG. 1). Finally, the program module 632 includes instructions for processing a first range and the second range to produce an improved range that is consistent with at least one potential active landmark position. In one embodiment, the program module 632 includes instructions for performing these steps at additional positions. The additional positions, i.e., locations, may be each separated from a respective prior position by a predefined separation distance.

To relate a Doppler shift in the return modulated pulse to an angular direction, the velocity of the device 610, or at least the magnitude of the velocity of the device 610, must be known. In some embodiments, the locomotion mechanism 642 includes an optoelectronic sensor that feeds frequency information thorough the interface 640 to the processor 622. Together with information about locomotion mechanism 642, the processor 622 converts this information into an estimation of the velocity of the device 610. In other embodiments, the return signals from the clutter provide a method to measure platform velocity (i.e., the velocity of the device). With sufficient clutter, the return signal power spectrum will have a bandwidth equal to twice the maximum Doppler shift. The maximum Doppler shift is numerically equal to a device velocity divided by the carrier signal wavelength. This type of measurement of the device velocity will, under some circumstances, be more accurate than those available from the locomotion mechanism 642. In these embodiments, the program module 632 contains instructions for the communications IC 620 to provide the necessary return signals corresponding to the clutter to the processor 622 such that the processor can calculate the return signal power spectrum. In still other embodiments, information on both differential and absolute bearing is also available from the Doppler shifts in the return signals. When a small change is made in the direction of the device velocity, both the reflected pulses from clutter and the return modulated pulses from the active landmarks 112 (FIG. 1) will shift in angle of arrival. Thus, cross-correlations in angle over time can be used to estimate integrated direction changes.

To detect a Doppler shift in the return signals corresponding to the clutter and/or in the return modulated pulse, the program modulate 632 contains Doppler calculation instructions 634 that are executed by the processor 622. The program modulate 632 also contains instructions for determining an angle between the particular direction of motion of the device 610 and the straight line between the device 610 and an active landmark, such as active landmark 112_1 (FIG. 1). In some embodiments, the processor 622 employs a fast Fourier transform (FFT) in the Doppler calculation 634. This technique is most accurate when the device 610 moves with a constant velocity, in a constant direction, while receiving one or more return signals. If accelerations are experienced by the device 610 while receiving the return signals, a pre-corrected FFT may be used for more accurate determination of Doppler shifts in the return signals and/or the return modulated pulse. The coefficients of such a pre-corrected FFT are, in some embodiments, determined from inertial sensors (not shown) of device velocity and direction.

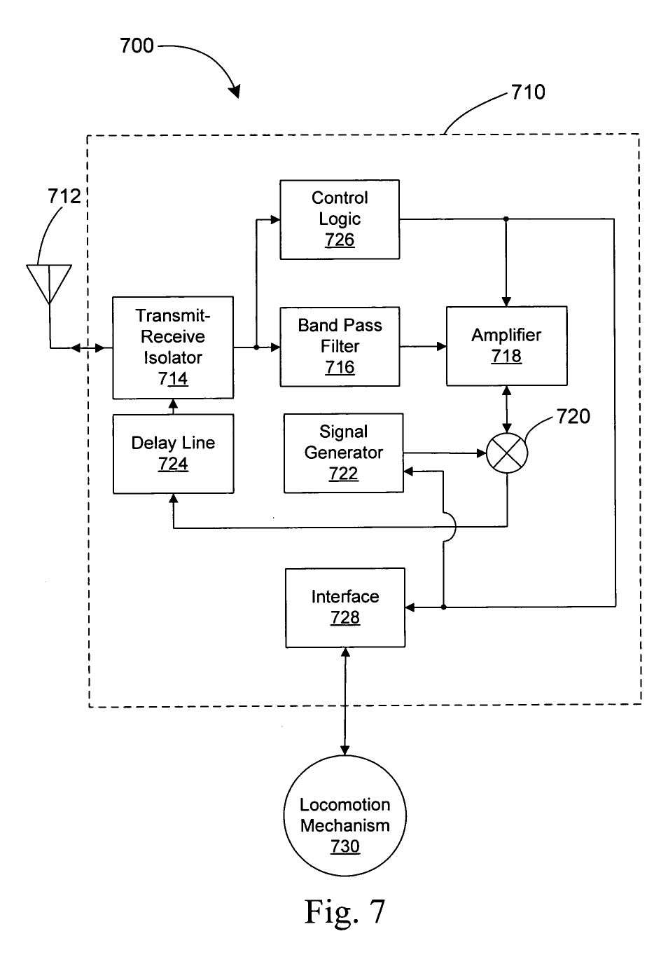

Referring to FIG. 7, an active landmark 710 in an embodiment of a local positioning system 700 includes:
an antenna 712 for receiving electromagnetic pulses and transmitting return modulated pulses;
a transmit-receive isolator 714;
an optional band pass filter 716;
an amplifier 718;
a modulator 720, such as a mixer;
a signal generator 722;
an optional delay line 724;
control logic 726;
an optional electromechanical interface circuit 728; and
an optional locomotion mechanism 730 for moving the active landmark 710 in a particular direction, at a velocity.

In some embodiments, the active landmark 710 is stationary. A receive signal corresponding to a pulse transmitted by the device 610 (FIG. 6) is received using the antenna 712. If the pulse is transmitted by the device 610 (FIG. 6) has a polarization, the antenna 712 may be configured to preferentially receive signals having the polarization. The receive signal is passed through the transmit-receive isolator 714 to isolate transmit and receive circuitry, the optional band pass filter 716 to band limit the receive signal and the amplifier 718 to amplify the receive signal. The receive signal is modulated in the modulator 720 with a modulating signal generated by the signal generator 722 to produce a transmit modulated signal. Modulation may be amplitude modulation or frequency modulation, as described above. In an exemplary embodiment, the modulating signal is a square wave having a fundamental frequency of several hundred Hertz. The transmit modulated signal is passed through an optional delay line 724 and the transmit-receive isolator 714 to the antenna 712 which transmits a return electromagnetic modulated pulse corresponding to the transmit modulated signal. The purpose of the delay line 724, if included, is to ensure that there is no significant overlap of the receive signal and the transmit modulated signal.

In some embodiments, the transmit-receive isolator 714 is a transmit receive switch. In other embodiments, the transmit-receive isolator 714 is a grating and the delay line 724 modifies the phase of the transmit modulated signal such that the grating routes the transmit modulated signal to the antenna 712. In other embodiments, the active landmark 710 includes a removable or rechargeable energy source such as a battery (not shown).

In an exemplary embodiment, the antenna 712 is configured to receive and transmit an electromagnetic pulse having a particular right- or left-hand polarization, such as circular or elliptical polarization. In some embodiments, the antenna 712 radiates isotropically in a plane containing the device 610 (FIG. 6) and the active landmark 710. An example of the antenna 712 that radiates substantially isotropically in a plane and transmits and receives electromagnetic pulses having a particular circular polarization is the antenna 712 formed from two cavity-backed spiral antennas, placed back-to-back. An example of such an antenna is described in “A new wideband cavity-backed spiral antenna,” Afsar et al., in Proceedings of the 2001 IEEE Antennas and Propagation Society International Symposium, vol. 4, pp. 124-127, which is hereby incorporated by reference in its entirety. In some embodiments, the antenna 712 is a directional horn antenna with a mechanical azimuthal actuator. In other embodiments, the antenna 712 includes a switched beam configuration using, for instance, a Rothman lens. In other embodiments, the antenna 712 includes electronically steerable phased-arrays. In still other embodiments the antenna 712 is linearly polarized, a bi-cone, a bi-cone with a ground plane, a helix, a horizontal omni-directional, an omni-directional, a hemi-directional and an isotropic antenna.

In other embodiments, the active landmark 710 has separate receive and transmit antennas, each having the polarization of the pulse transmitted by the device 610 (FIG. 6), and the transmit-receive isolator 714 and the delay line 724 are not included.

In some embodiments, the modulating signal generated by the signal generator 722 may be programmed, thereby enabling a control device to change the modulating signal or encoding of the modulating signal, such as the fundamental frequency of a square wave or the encoding of a square wave. Control information corresponding to the modification of the signal generator may be encoded in the pulse transmitted by the device 610 (FIG. 6). Alternatively, the control information may be transmitted in a separate wireless signal between the device 610 (FIG. 6) to the active landmark 710. The control logic 726 identifies this control information and modifies settings in the signal generator 722 based on these instructions. In some embodiments, the control information is provided by a device separate from the device 610, for example a control and calibration device.

In some embodiments, a separate wireless link may be used to enable power saving modes in the active landmark 710. This is particularly useful in those embodiments where the active landmark includes a removable or rechargeable energy source. If the removable or rechargeable energy source can be used sparingly, maintenance of the active landmark 710 is reduced. In an exemplary embodiment, the amplifier 718 is placed in a power saving mode. Prior to the device 610 (FIG. 6) transmitting a pulse, a wireless signal including a command instruction such as synchronization signal to increase the amplifier power is transmitted to the active landmark 710. The control logic 726 identifies this control information and powers up the amplifier 718. After a predefined time, bracketing the transmitting of the pulse by the device 610 (FIG. 6), the control logic 726 may power down the amplifier 718. Alternatively, a second wireless signal including a command instruction to decrease the amplifier power is transmitted by the device 610 (FIG. 6) to the active landmark 710. The control logic 726 identifies this control information and powers down the amplifier 718. In another embodiment, the device 610 (FIG. 6) and the active landmark 710 have synchronized clocks. Pulses are transmitted at known times and the amplifier 718 is powered up and down, respectively, during a time window bracketing the transmissions. These approaches enable synchronization of the power to the amplifier 718 with the transmitted pulse from the device 610 (FIG. 6).

In some embodiments, the active landmark 710 is moveable about an average fixed location. The control logic 726 implements this capability by signaling interface 728, which in turn activates locomotion mechanism 730. In some embodiments, mechanism 730 includes an electric motor, the speed of which is controlled by the level of a DC voltage provided by the interface 728. In some embodiments, the control logic 726 performs this function in response to command signals from the device 610 (FIG. 6) encoded in the transmitted pulse from the device 610 (FIG. 6) or in a separate wireless link. In order for the device 610 (FIG. 6) to determine angular information from the resulting Doppler shifts in the return modulated pulse, the device 610 (FIG. 6) will need to know the direction 412 (FIG. 4B) in which the active landmark 710 is moving.

There are alternatives for the active landmarks 112 (FIG. 1). In some embodiments, the active landmarks 112 (FIG. 1) may be fluorescent light bulbs. Transmitted pulses from the device 610 (FIG. 6) will be reflected off of the fluorescent light bulbs. These reflected pulses will be modulated, thereby corresponding to return modulated pulses. The return modulated pulses from the fluorescent light bulbs are frequency modulated characterized by a central frequency two times an alternating current frequency in the bulb. The modulation is a result of symmetry in the reflecting property of plasma waves traveling up and down the fluorescent light bulb. By adjusting the alternating current frequency in the fluorescent light bulb, a respective fluorescent light bulb can have a distinct modulation. These embodiments may be useful in warehouse environments where fluorescent light bulbs are already installed on the ceiling and can serve as active landmarks. In such embodiments, the antenna 612 (FIG. 6) may be isotropic.

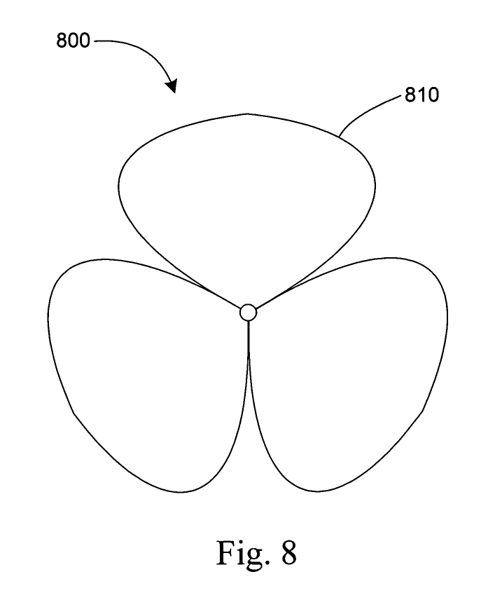

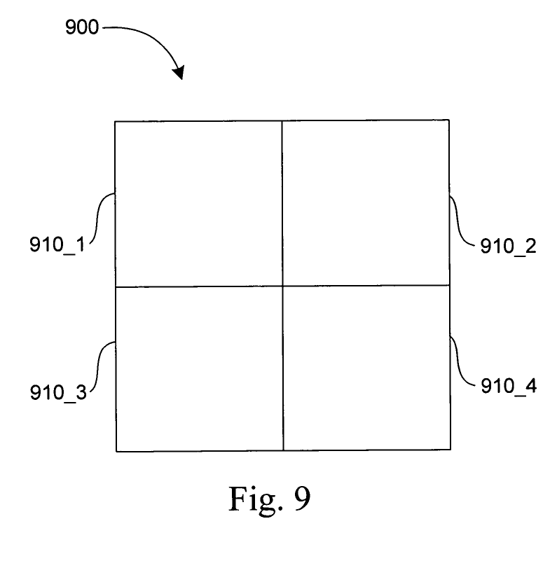

In other embodiments, the active landmarks 112 (FIG. 1) have a time and spatially varying reflectivity on a surface that amplitude modulates the return modulated pulses. FIG. 8 illustrates one such embodiment 800 of the active landmarks 112 (FIG. 1), a mechanically rotating wheel 810 for generating amplitude modulation corresponding to the rate of rotation of the wheel 810. FIG. 9 illustrates yet another such embodiment 900 by selectively modifying the reflectivity of cells 910. The cells 910 may be liquid crystal reflectors whose reflectivity is adjusted by applying a voltage to the cells 910.

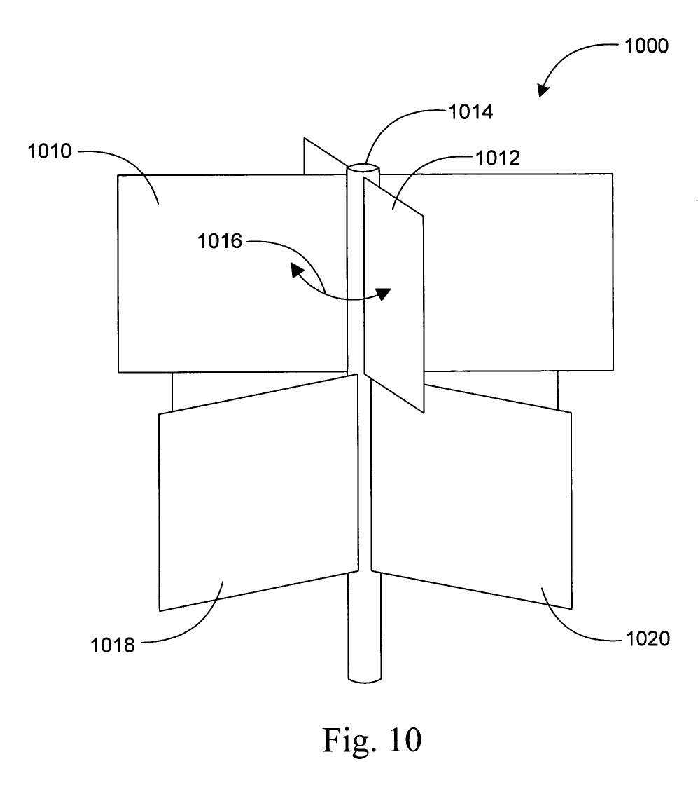

The active landmarks 112 (FIG. 1), such as active landmark 710, enable the device 610 (FIG. 6) to isolate one or more return modulated pulses from the return signals. However, the active landmarks 112 (FIG. 1), such as a fluorescent light bulb, may have a limited radar cross section. To increase this cross section, in some embodiments a passive reflector structure is placed proximate to the active landmarks 112 (FIG. 1). Referring to FIG. 10, a combined landmark 1000 includes an active landmark 1014 having a modulator, a first passive reflector 1010 for reflecting electromagnetic pulses, a second passive reflector 1012 for reflecting electromagnetic pulses and a static structure (not shown, but possibly formed from a housing or structural component of the active landmark) configured to statically position the second passive reflector 1012 at an angle 1016 relative to the first passive reflector 1010. Examples of materials that may be employed to manufacture passive reflectors 1010 and 1012 that reflect electromagnetic pulses include, but are not limited to, conductors such as aluminum, copper and other metals. The shape of passive reflectors in some embodiments is different than that of those depicted in FIG. 10, for instance having rounded corners that would be less likely to lacerate a person, or designed to fit more easily into a protective container, such as a plastic sphere.

As an illustration of the function of the combined landmark 1000, if an electromagnetic pulse having a first circular polarization (RHCP or LHCP) is incident upon the first passive reflector 1010 it will be reflected with a second circular polarization (LHCP or RHCP, respectively). Then, the pulse reflected by the first passive reflector 1010 will be reflected by the second passive reflector 1012 with the first circular polarization (RHCP or LHCP, respectively). So that the pulse reflected by the second passive reflector 1012 travels in the direction opposite to that of the original incident pulse, ultimately arriving at the device 610 (FIG. 6) that transmitted the original pulse, angle 1016 is about 90°. Due to manufacturing tolerances and mechanical disturbances once deployed as a combined landmark 1000, it may not be possible for angle 1016 to be precisely 90°. Also, since the reflectors are of finite length and may only be a few carrier signal wavelengths long, the re-radiation pattern, in exemplary embodiments, will be strong over several degrees. In some embodiments, the device 610 (FIG. 6) will transmit pulses in more than one direction and will be sensitive to return signals from more than one direction, so angle 1016 may include 90°±3°. In other embodiments, useful angles 1016 may include 90°±10°.

Return signals from the combined landmark 1000 will include the return modulated pulse as well as the reflected pulse. In those embodiments where the pulse transmitted by the device 610 (FIG. 6) is polarized, both the return modulated pulse and the reflected pulse from the combined landmark 1000 will have the same polarization. The return modulated pulse can be used to distinctly identify the respective combined landmark 1000 and the reflected pulse can increase the overall signal-to-noise of the return signal at the device 610 (FIG. 6) by increasing the cross section.

In the previous illustration, a circularly polarized electromagnetic pulse that is incident on the edge of first passive reflector 1010 or second passive reflector 1012 will be reflected only once, by the second 1012 or the first passive reflector 1010 respectively, and will therefore be reflected with a different circular polarization than that with which it was incident. In this case, the device 610 (FIG. 6) would not be able to isolate reflected pulses from the combined landmark 1000 from pulses reflected by other objects in the environment. To remedy this problem, in some embodiments the combined landmark 1000 further includes a third passive reflector 1018 and a fourth passive reflector 1020. The static structure is further configured to statically position reflector 1018 at an angle (not shown) of about 90° relative to reflector 1020. The static structure is further configured to statically position reflector 1018 at an angle (not shown) different than zero relative to reflector 1010. The angle between reflectors 1010 and 1018 may be about 45°. In an exemplary embodiments the angle between reflectors 1010 and 1018 is between 30° and 60°. In other exemplary embodiments the angle between reflectors 1010 and 1018 is between 1° and 89°. Reflectors 1010 and 1012 form a first dihedral pair. Similarly, reflectors 1018 and 1020 form a second dihedral pair. By positioning the reflector 1018 at an angle different than zero relative to reflector 1010, when a circularly polarized electromagnetic pulse is incident on the edge of one of the reflectors in the first dihedral pair, the pulse will not be incident on the edges of either of the reflectors in the second dihedral pair. Similarly, a pulse incident on the edge of one of the reflectors in the second dihedral pair will not be incident on the edges of either of the reflectors in the first dihedral pair. Thus, any circularly polarized pulse incident on the combined landmark 1000 will generate at least one reflected pulse having the same circular polarization. In other embodiments, the combined landmark 1000 may include trihedral reflectors, other wise known as “corner cube” reflectors. In still other embodiments, the combined landmark 1000 may include a Lunenburg lens.

The foregoing description, for purposes of explanation, used specific nomenclature to provide a thorough understanding of the invention. However, it will be apparent to one skilled in the art that the specific details are not required in order to practice the invention. The embodiments were chosen and described in order to best explain the principles of the invention and its practical applications, to thereby enable others skilled in the art to best utilize the invention and various embodiments with various modifications as are suited to the particular use contemplated. Thus, the foregoing disclosure is not intended to be exhaustive or to limit the invention to the precise forms disclosed. Many modifications and variations are possible in view of the above teachings.

It is intended that the scope of the invention be defined by the following claims and their equivalents.

1. A method of determining the position of a device relative to an active landmark, comprising:
transmitting a pulse having a polarization and a first carrier signal frequency from the device;
receiving a return signal over a period of time, wherein the return signal includes a return modulated pulse from the active landmark and the receiving includes preferentially receiving return signals having the polarization; and
processing the return signal so as to isolate the return modulated pulse from the return signal and to determine a range from the device to the active landmark.

2. The method of claim 1, wherein the polarization is selected from the group consisting of linear polarization, elliptical polarization, right-hand elliptical polarization, left-hand elliptical polarization, right-hand circular polarization and left-hand circular polarization.

3. The method of claim 1, further comprising using at least one antenna with a preferred polarized for both the transmitting and receiving.

4. The method of claim 1, wherein the return modulated pulse is amplitude modulated.

5. The method of claim 1, wherein the return modulated pulse is frequency modulated and has at least a second carrier signal frequency, and wherein modulation of the return modulated pulse frequency shifts the second carrier signal frequency relative to the first carrier signal frequency by further than a band of frequencies corresponding to Doppler shifts associated with relative motion of the device and objects within its radar detection area.

6. The method of claim 5, wherein the modulation of the return modulated pulse is characterized by a central frequency.

7. The method of claim 5, wherein the modulation of the return modulated pulse is a square wave with a fundamental frequency.

8. The method of claim 7, wherein the square wave is encoded to eliminate ambiguity in a time of arrival of the return modulated pulse.

9. The method of claim 8, wherein the square wave is encoded using a technique selected from the group consisting of on-off keying, quadrature amplitude modulation, continuous phase frequency shift keying, frequency shift keying, phase shift keying, differential phase shift keying, quadrature phase shift keying, minimum shift keying, Gaussian minimum shift keying, pulse position modulation, pulse amplitude modulation, pulse width modulation, Walsh code modulation, Gold code modulation, Barker code modulation, pseudo-random-noise sequence modulation, and dc-free codes having an autocorrelation of 1 at zero time offset and substantially near zero at non-zero time offset.

10. The method of claim 8, wherein the square wave is periodically encoded to distinguish round-trip paths that are a multiple of a repetition period of the transmitted pulse.

11. The method of claim 1, further comprising:
receiving a plurality of return modulated pulses in the return signal, the plurality of return modulated pulses corresponding to a plurality of active landmarks; and
processing the return signal so as to isolate a respective return modulated pulse from the return signal and to determine the range from the device to a respective active landmark.

12. The method of claim 11, wherein modulation of the return modulated pulse from a respective active landmark is distinct from that used by at least a plurality of other active landmarks.

13. The method of claim 12, wherein the return modulated pulse from a respective active landmark is frequency modulated and has at least a second carrier signal frequency, and wherein modulation of the return modulated pulse frequency shifts the second carrier signal frequency relative to the first carrier signal frequency further than a band of frequencies corresponding to Doppler shifts associated with relative motion of the device and objects within its radar detection area.

14. The method of claim 13, wherein the modulation of the return modulated pulse is a square wave with a fundamental frequency and a plurality of active landmarks have respective distinct fundamental frequencies.

15. The method of claim 13, wherein the modulation of the return modulated pulse is characterized by a central frequency and a plurality of active landmarks have respective distinct central frequencies.

16. The method of claim 12, wherein the return modulated pulse from a respective active landmark is amplitude modulated.

17. The method of claim 1, further comprising:
moving the device at a velocity in a particular direction while performing the receiving;
detecting a Doppler shift in the return modulated pulse in the return signal; and
determining an angle between the particular direction and a straight line between the device and the active landmark as a function of the detected Doppler shift.

18. The method of claim 1, further comprising:
moving the active landmark at a velocity in a particular direction while performing the receiving;
detecting a Doppler shift in the return modulated pulse in the return signal; and
determining an angle between the particular direction and a straight line between the device and the active landmark as a function of the detected Doppler shift.

19. The method of claim 1, further comprising determining the position of the device over distances greater than a threshold using radar-to-radar ranging with a second device.

20. The method of claim 19, further comprising encoding data information used in radar-to-radar ranging in signals exchanged by the device and the second device.

21. A positioning system, comprising
an active landmark, wherein the active landmark includes a modulator; and
a device configured to transmit an electromagnetic pulse having a polarization and a first carrier signal frequency, to receive a return signal including a return modulated pulse from the active landmark over a period of time, to process the return signal so as to isolate the return modulated pulse from the return signal and to determine a range from the device to the active landmark;
wherein the device preferentially receives return signals having the polarization.

22. The system of claim 21, wherein the polarization is selected from the group consisting of linear polarization, elliptical polarization, right-hand elliptical polarization, left-hand elliptical polarization, right-hand circular polarization and left-hand circular polarization.

23. The system of claim 21, the device further including at least one antenna configured to preferentially receive signals having the polarization.

24. The system of claim 21, the device further including at least one antenna configured to both preferentially transmit the pulse having the polarization and to preferentially receive signals having the polarization.

25. The system of claim 21, the device further including an antenna selected from the group consisting of linearly polarized and circularly polarized.

26. The system of claim 21, the device further including an antenna selected from the group consisting of a bi-cone, a bi-cone with a ground plane, a helix, a horizontal omni-directional, an omni-directional, a hemi-directional and an isotropic antenna.

27. The system of claim 21, the device further including a de-coherence plate to reduce cross-talk between a transmit antenna and a receive antenna, wherein for a plurality of paths over a range of paths from the transmit antenna to the receive antenna the de-coherence plate substantially defines a corresponding path that is 180° out of phase.

28. The system of claim 21, the active landmark further including a ground plane to reduce cross-talk between a transmit antenna and a receive antenna.

29. The system of claim 21, further comprising a passive reflective structure proximate to the active landmark.

30. The system of claim 29, in which the passive reflective structure is selected from the group consisting of a dihedral and a corner cube.

31. The system of claim 21, the device further including:
a vehicle locomotion mechanism for moving the device in a particular direction, at a velocity;
a data processor;
at least one program module, executed by the data processor, the at least one program module containing instructions for:
detecting a Doppler shift in the return modulated pulse in the return signal; and
determining an angle between the particular direction and a straight line between the device and the active landmark.

32. The system of claim 21, the active landmark further including a mechanism for moving the active landmark in a particular direction, at a velocity; and
the device further including:
a data processor;
at least one program module, executed by the data processor, the at least one program module containing instructions for:
detecting a Doppler shift in the return modulated pulse in the return signal; and
determining an angle between the particular direction and a straight line between the device and the active landmark.

33. The system of claim 21, wherein the device modulates the return signal with a modulating signal used to generate the return modulated pulse so as to isolate the return modulated pulse from the return signal.

34. The system of claim 21, wherein the return modulated pulse is amplitude modulated.

35. The system of claim 21, wherein the return modulated pulse is frequency modulated and has at least a second carrier signal frequency, and wherein the second carrier signal frequency is shifted relative to the first carrier signal frequency further than a band of frequencies corresponding to Doppler shifts associated with relative motion of the device and objects within its radar detection area.

36. The system of claim 35, wherein the return modulated pulse has a modulation characterized by a central frequency.

37. The system of claim 35, wherein the return modulated pulse has a square wave modulation with a fundamental frequency.

38. The system of claim 37, wherein the square wave is encoded to eliminate ambiguity in a time of arrival of the return modulated pulse.

39. The system of claim 38, wherein the square wave is encoded using a technique selected from the group consisting of on-off keying, quadrature amplitude modulation, continuous phase frequency shift keying, frequency shift keying, phase shift keying, differential phase shift keying, quadrature phase shift keying, minimum shift keying, Gaussian minimum shift keying, pulse position modulation, pulse amplitude modulation, pulse width modulation, Walsh code modulation, Gold code modulation, Barker code modulation, pseudo-random-noise sequence modulation, and dc-free codes having an autocorrelation of 1 at zero time offset and substantially near zero at non-zero time offset.

40. The system of claim 38, wherein the square wave is periodically encoded to distinguish round-trip paths that are a multiple of a repetition period of the transmitted pulse.

41. The system of claim 21, further comprising:
a plurality of active landmarks, wherein the return signal includes a plurality of return modulated pulses corresponding to the plurality of active landmarks; and
the device is configured to process the return signal so as to isolate a respective return modulated pulse from the return signal and to determine the range from the device to a respective active landmark.

42. The system of claim 41, wherein the return modulated pulse from a respective active landmark has a modulation distinct from that used by at least a plurality of other active landmarks.

43. The system of claim 42, wherein the return modulated pulse from a respective active landmark is frequency modulated and has at least a second carrier signal frequency, and wherein the second carrier signal frequency is shifted relative to the first carrier signal frequency further than a band of frequencies corresponding to Doppler shifts associated with relative motion of the device and objects within its radar detection area.

44. The system of claim 43, wherein the return modulated pulse from a respective active landmark has a square wave modulation with a fundamental frequency and a plurality of active landmarks have respective distinct fundamental frequencies.

45. The system of claim 43, wherein the return modulated pulse from a respective active landmark has a modulation characterized by a central frequency and a plurality of active landmarks have respective distinct central frequencies.

46. The system of claim 42, wherein the return modulated pulse from a respective active landmark is amplitude modulated.

47. The system of claim 21, the active landmark further including:
a receive antenna for receiving a receive signal corresponding to the transmitted electromagnetic pulse;
an amplifier for amplifying the receive signal;
a signal generator for generating a modulating signal;
a mixer for modulating the receive signal with the modulating signal to produce a transmit modulated signal; and
a transmit antenna for transmitting a return electromagnetic modulated pulse corresponding to the transmit modulated signal.

48. The system of claim 47, the active landmark further including a band-pass filter for band limiting the receive signal.

49. The system of claim 47, the active landmark further including a removable energy source.

50. The system of claim 47, the signal generator is programmable to contain and execute instructions for changing the modulating signal generated by the signal generator and thereby changing a modulation of the transmitted modulated pulse.

51. The system of claim 47, the signal generator is programmable to contain and execute instructions for changing the modulating signal generated by the signal generator and thereby changing an encoding of the transmitted modulated pulse.

52. The system of claim 47, wherein the transmit antenna and the receive antenna are combined in a common antenna, and the active landmark further includes a delay line and a transmit-receive grating for transmit-receive isolation of time multiplexed signals.

53. The system of claim 47, wherein the transmit antenna and the receive antenna are combined in a common antenna, and the active landmark further includes a transmit-receive switch for transmit-receive isolation of time multiplexed signals.

54. The system of claim 47, wherein the receive antenna and the transmit antenna are selected from the group consisting of linearly polarized and circularly polarized.

55. The system of claim 47, wherein the receive antenna and the transmit antenna are each selected from the group consisting of bi-cone, bi-cone with a ground plane, helix, horizontal omni-directional, omni-directional, hemi-directional and isotropic antennas.

56. The system of claim 21, wherein the device is further configured to store at least a calibrated delay for at least a respective active landmark and the range from the device to the active landmark is determined using the calibrated delay.

57. The system of claim 21, wherein the device is further configured to transmit wireless synchronization signals to the active landmark, the synchronization signals synchronizing power to an amplifier in the active landmark with the transmitted pulse.

58. The system of claim 21, wherein the active landmark is a fluorescent light bulb and the return modulated pulse is frequency modulated characterized by a central frequency two times an alternating current frequency in the fluorescent light bulb.

59. The system of claim 21, wherein the active landmark has a time varying and a spatially varying reflectivity on a surface that determines an amplitude modulation of the return modulated pulse.

60. The system of claim 59, the active landmark further including a mechanically rotating wheel.

61. The system of claim 59, the active landmark further including a liquid crystal reflector.

62. The system of claim 21, further comprising a second device, wherein the position of the device over distances greater than a threshold is determined using radar-to-radar ranging between the device and the second device.

63. The system of claim 62, the device further including a modulator and a demodulator, wherein the modulator and the demodulator are used to encode and decode data information used in radar-to-radar ranging in signals exchanged by the device and the second device.
